(19) United States
(12) Patent Application Publication
(10) Pub. No.: US 2005/0115423 A1
(43) Pub. Date: Jun. 2, 2005

(54) Dampening water feeding apparatus

(76) Inventor: Motoshi Aoyama, Shizuoka (JP)

Correspondence Address: MORGAN & FINNEGAN, L.L.P., 3 World Financial Center, New York, NY, 10281-2101, US

(21) Appl. No.: 10/975,901

(22) Filed: Oct. 28, 2004

(30) Foreign Application Priority Data
Oct. 31, 2003 (JP) 2003-373833

(51) Int. Cl. B41F 7/30

(52) U.S. Cl. 101/147

(57) ABSTRACT

An apparatus is arranged to feed dampening water in an offset printing press. The apparatus comprises a plurality of spray nozzles arranged in a row in a direction. Each of the nozzles includes an outlet formed therein for spraying the dampening water. The outlet has a cross section elongated in the direction in which the nozzles are arranged in the row, to spray the dampening water in an increasing fan-shaped area defined in the direction in which the nozzles are arranged in the row. The apparatus further comprises baffle means disposed at least on the opposite sides of each of the nozzles in the direction in which the nozzles are arranged in the row, to baffle air stream from being directed toward the nozzle when spraying and stopping the dampening water.

### FIELD OF THE INVENTION

The invention relates to an apparatus for feeding dampening water in an offset printing press.

### PRIOR ART

An apparatus has been commercially available for feeding dampening water in an offset printing press, as disclosed in Japanese Patent No. 2,746,975. The apparatus is a spray-type including a plurality of spray nozzles arranged in a row in a direction. Each of the nozzles includes an outlet formed therein for spraying the dampening water. The outlet comprises a slit having a cross section elongated in the direction in which the nozzles are arranged in the row, to spray the dampening water in an increasing fan-shaped area defined in the direction in which the nozzles are arranged in the row.

The apparatus involves ink mist generated by the printing press and drifted around the apparatus. Lint is also generated by the printing press and drifted around the apparatus. In addition, air stream is generated under the influence of dampening water especially on the opposite sides of each of the nozzles in the direction in which the nozzles are arranged in the row, to be directed toward the nozzle when spraying the dampening water. The air stream is strengthened under the influence of dampening water for a moment to be directed toward the nozzle when stopping the dampening water.

Accordingly, the ink and lint are entrained on the air stream and directed toward the nozzle to be adhered to and deposited on the nozzle. It is therefore required to frequently clean the nozzle of ink and lint. The outlet may be clogged with ink and lint. In this case, the apparatus cannot conveniently spray the dampening water in the fan-shaped area, resulting in defect or poor quality of printed product.

It is therefore an object of the invention to provide a new and improved apparatus for feeding dampening water in an offset printing press, to overcome the above problems. The apparatus comprises a plurality of spray nozzles arranged in a row in a direction. Each of the nozzles includes an outlet formed therein for spraying the dampening water. The outlet has a cross section elongated in the direction in which the nozzles are arranged in the row, to spray the dampening water in an increasing fan-shaped area defined in the direction in which the nozzles are arranged in the row.

Other object is to provide the apparatus in which it is not required to frequently clean the nozzle of ink and lint.

Other object is to provide the apparatus which can keep the outlet from being clogged with ink and lint to conveniently spray the dampening water in the fan-shaped area, without resulting in defect or poor quality of printed product.

### SUMMARY OF THE INVENTION

According to the invention, the apparatus further comprises baffle means disposed at least on the opposite sides of each of the nozzles in the direction in which the nozzles are arranged in the row, to baffle air stream from being directed toward the nozzle when spraying and stopping the dampening water.

In a preferred embodiment, the nozzles are arranged longitudinally of a dampening roller to spray the dampening water onto the dampening roller.

Each of the nozzles includes a groove formed therein. The groove has a bottom and extends in the direction in which the nozzles are arranged in the row. The outlet is formed in the bottom centrally thereof in the direction in which the nozzles are arranged in the row. The baffle means is higher than the nozzle to baffle the air stream from being directed toward the groove and the outlet.

The baffle means comprises a baffle wall which is annular to be disposed around each of the nozzles.

A nut is disposed around each of the nozzles so that the nozzle can be fixed to a solenoid valve by the nut. The baffle wall is formed integrally with the nut.

The baffle means may extend toward the fan-shaped area and terminate at a position near the fan-shaped area.

The baffle moans may extend toward the fan-shaped area and terminate at a position tangent to the fan-shaped area.

### BRIEF DESCRIPTION OF THE DRAWINGS

FIG. 1 is a schematically perspective view of a preferred embodiment of the invention.

FIG. 2 is a sectional view of the apparatus of FIG. 1.

FIG. 3 is a plan view of the nozzle of FIG. 2.

FIG. 4 is a sectional view of the nozzle of FIG. 2.

FIG. 5 is an explanatory view of the dampening roller of FIG. 1 having dampening water receiving portions.

FIG. 6 is a sectional view of other embodiment.

FIG. 7 is a sectional view of other embodiment.

FIG. 8 is a sectional view of other embodiment.

FIG. 9 is a sectional view of other embodiment.

FIG. 10 is a sectional view of other embodiment.

FIG. 11 is a plan view of other embodiment.

### DETAINED DESCRIPTION OF THE PREFERRED EMBODIMENTS

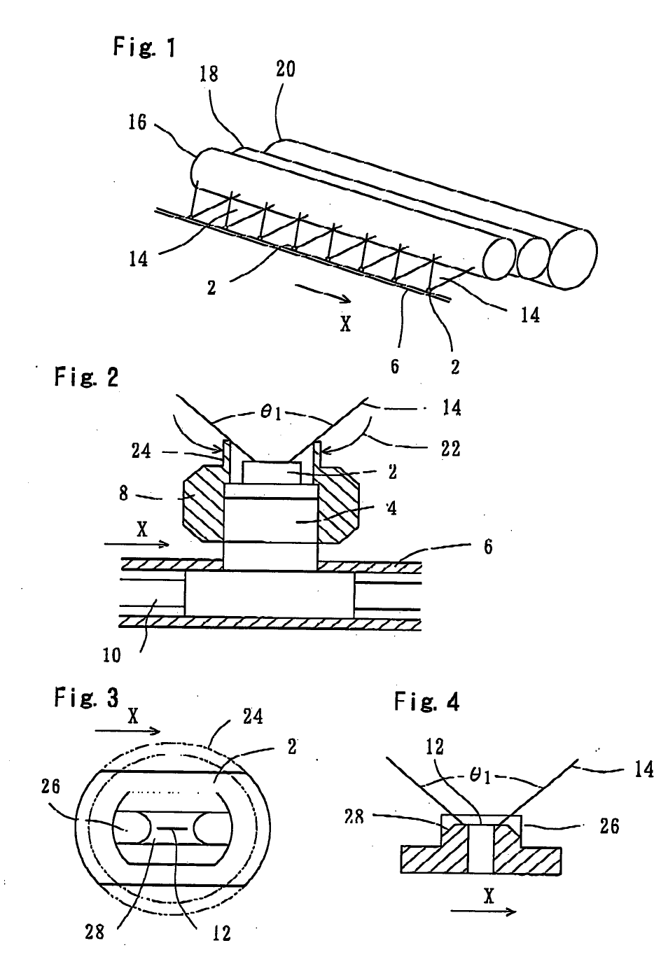

Turning now to the drawings, FIG. 1 illustrates an apparatus for feeding dampening water in an offset printing press, according to the invention. The apparatus is a spray-type including a plurality of nozzles 2 arranged in a row in a direction X. The apparatus further includes a plurality of solenoid valves 4 received in and protruding from a spray bar 6, as shown in FIG. 2. A nut 8 is disposed around each of the nozzles 2 and threadedly engaged with the solenoid valve 4 so that the nozzle 2 can be fixed to the solenoid valve 4 by the nut 8. A pipe 10 is received in the spray bar 6 and connected to tho solenoid valve 1 so that dampening water can be directed to the solenoid valve 4 through the pipe 10. The dampening water is supplied to the nozzle 2 through the solenoid valve 4.

Each of the nozzles 2 includes an outlet 12 formed therein for spraying the dampening water, as shown in FIG. 3. The outlet 12 comprises a slit having a cross section elongated in the direction X in which tho nozzles 2 are arranged in the row, to spray the dampening water in an increasing fan-shaped area 14 defined in the direction X in which the nozzles 2 are arranged in the row. The fan-shaped area 14 has an angle θ 1.

The nozzles 2 are arranged longitudinally of a dampening roller 16 to spray the dampening water onto the dampening roller 16. The dampening roller 16 comprises a fountain roller disposed in contact with a ducter roller 18 which lo disposed in contact with a plate cylinder 20 so that the fountain roller 16 can cooperate with the ducter roller 18 to feed the dampening water to the plate cylinder 20.

It should be recognized that the apparatus involves ink mist generated by the printing press and drifted around the apparatus. Lint is also generated by the printing press and drifted around the apparatus. In addition, air stream 22 is generated under the influence of dampening water especially on the opposite sides at each of the nozzles 2 in the direction X in which the nozzles 2 are arranged in the row, to be directed toward the nozzle 2 when spraying the dampening water. The air stream 22 is strengthened under the influence of dampening water for a moment to be directed toward the nozzle 2 when stopping the dampening water.

Under the circumstances, the apparatus further includes baffle means 24 disposed at least on the opposite sides of each of the nozzles 2 in the direction X in which the nozzles 2 are arranged in the row, to baffle air stream 22 from being directed toward the nozzle 2 when spraying and stopping the dampening water.

Accordingly, the ink and lint are merely entrained on the air stream 22 not to be directed toward the nozzle 2. The apparatus can therefore prevent the ink and lint from being adhered to and deposited on the nozzle 2. As a result, it is not required to frequently clean the nozzle 2 of ink and lint. The apparatus can also keep the outlet 12 from being clogged with ink and lint, to conveniently spray the dampening water in the fan-shaped area 14, without resulting in defect or poor quality of printed product.

In the embodiment, each of nozzles 2 includes a groove 26 formed therein, as shown in FIG. 4. The groove 26 has a bottom 28 and extends in the direction X in which the nozzles 2 are arranged in the row. The outlet 12 is formed in the bottom 28 centrally thereof in the direction X in which the nozzles 2 are arranged in the row. The baffle means 24 is higher than the nozzle 2 to baffle the air stream 22 from being directed toward the groove 26 and the outlet 12.

The apparatus can therefore prevent the ink and lint from being adhered to and deposited on the bottom 28. The arrangement can also keep the outlet 12 from being clogged with ink and lint.

In addition, the baffle moons 24 comprises a baffle wall which 16 annular to be disposed around each of the nozzles 2. The baffle wall 24 is formed integrally with the nut 8.

Accordingly, the baffle wall 24 can be incorporated into the apparatus without difficulty when the nozzle 2 is fixed to the solenoid valve 4 by the nut 8. The baffle wall 24 can baffle the air stream 22 from being directed toward the nozzle 2 even if the air stream 22 is generated not only on the opposite sides of each of the nozzles 2 but also around of each of the nozzles 2.

Furthermore, the baffle wall 24 extends toward the fan-shaped area 14 and terminates at a position near the fan-shaped area 14. The baffle wall 24 can therefore intercept the air stream 22 effectively. The air stream 22 cannot be directed toward the nozzle 2 at all.

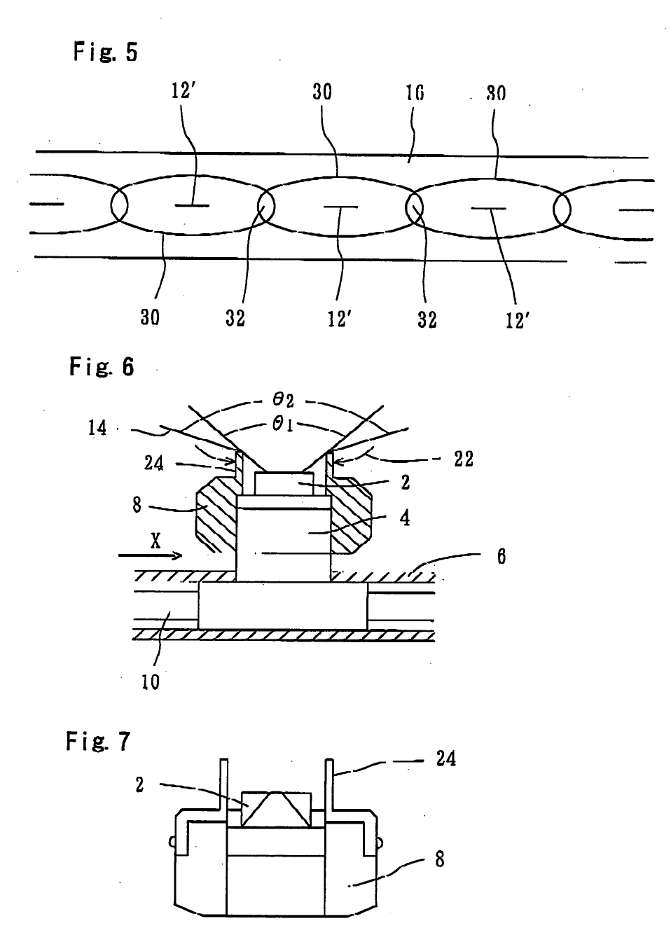

It should be recognized that the dampening roller 16 has dampening water receiving portions 30 onto each of which the outlet 12 sprays the dampening water, as shown in FIG. 5. The nozzles 2 are arranged longitudinally of the dampening roller 16, as described above. The outlet 12 has the cross section elongated and sprays the dampening water in the fan-shaped area 14, as also described above. The receiving portions 30 are formed around the positions 12′ of outlets 12 imaginatively projected in FIG. 5, to be arranged and elongated longitudinally of the dampening roller 16. In addition, overlapping portions 32 are formed between the receiving portions 30 not to be short of dampening water between the receiving portions 30.

In this connection, the battle wall 24 may extend toward the fan-shaped area 14 and terminate at a position tangent to the fan-shaped area 14, as shown in FIG. 6. In this case, it has been confirmed by test that the baffle wall 24 makes the dampening water refracted outwardly of the fan-shaped area 14 so that the fan-shaped area 14 can be enlarged into an enlarged area having an angle θ 2. Accordingly, the overlapping portions 32 are enlarged by means of the enlarged areas 14. The arrangement can therefore spray the dampening water uniformly throughout the length of the dampening roller 16 to improve the quality of printed product.

The baffle wall 24 may be fixed to the nut 8 by screws or the like, as shown in FIG. 7. The baffle wall 24 may be annular to have a cross section of circle or not circle. The baffle wall 24 may be continuous. The baffle wall 24 may include slits formed therein to be not continuous.

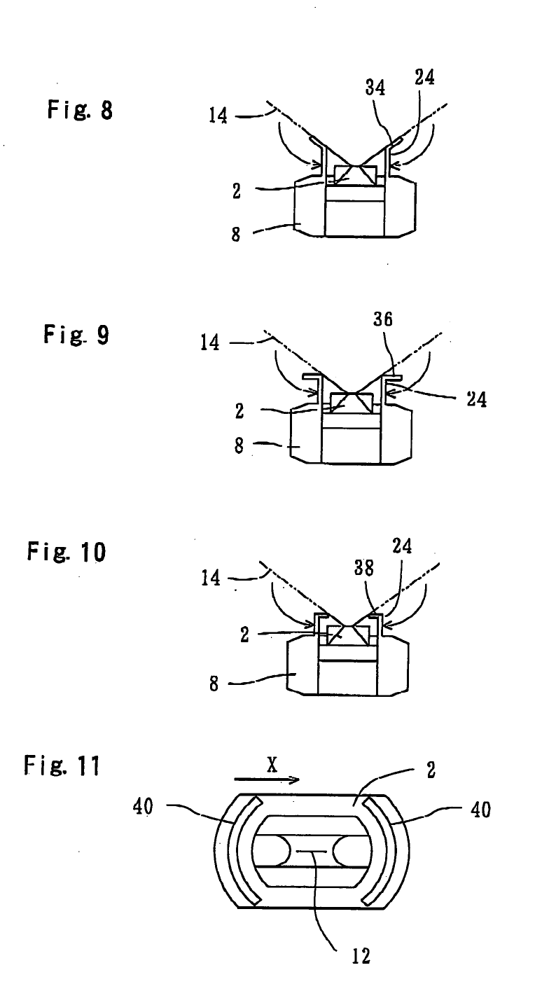

The baffle wall 24 may include an end portion 34 inclined outwardly at an angle corresponding to the angle θ 1 of the fan-shaped area 14, as shown in FIG. 8.

The baffle wall 24 may include an end portion 36 bent outwardly, as shown in FIG. 9.

The baffle wall 24 may include an end portion 38 bent inwardly, as shown in FIG. 10.

A pair of baffle walls 40 may be disposed on the opposite sides of each of the nozzles 2 in the direction in which the nozzles 2 are arranged in the row, as shown in FIG. 11.

1. An Apparatus for feeding dampening water in an offset printing press, said apparatus comprising:
a plurality of spray nozzles arranged in a row in a direction, each of the nozzles including an outlet formed therein for spraying the dampening water, the outlet having a cross section alongated in the direction in which the nozzles are arranged in the row, to spray the dampening water in an increasing fan-shaped area defined in the direction in which the nozzles are arranged in the row; and
baffle means disposed at least on the opposite sides of each of the nozzles in the direction in which the nozzles are arranged in the row, to baffle air stream from being directed toward the nozzle when spraying and stopping the dampening water.

2. The apparatus as set forth in claim 1 wherein the nozzles are arranged longitudinally of a dampening roller to spray the dampening water onto the dampening roller.

3. The apparatus as set forth in claim 1 wherein the baffle means comprises a baffle wall which is annular to be disposed around each of the nozzles.

4. The apparatus as set forth in claim 1 wherein each of the nozzles includes a groove formed therein, the groove having a bottom and extending in the direction in which the nozzles are arranged in the row, the outlet being formed in the bottom centrally thereof in the direction in which the nozzles are arranged in the row, the baffle means being higher than the nozzle to baffle the air stream from being directed toward the groove an the outlet.

5. The apparatus as set forth in claim 4 wherein the baffle means comprises a baffle wall which is annular to be disposed around each of the nozzles.

6. The apparatus as set forth in claim 5 wherein a nut is disposed around each of the nozzles so that the nozzle can be fixed to a solenoid valve by the nut, the baffle wall being formed integrally with the nut.

7. The apparatus as set forth in claim 1 wherein the baffle means extends toward the fan-shaped area and terminates at a position near the fan-shaped area.

8. The apparatus as set forth in claim 1 wherein the baffle means extends toward the fan-shaped area and terminates at a position tangent to the fan-shaped area.
